(19) United States
(12) Patent Application Publication
(10) Pub. No.: US 2017/0006834 A1
(43) Pub. Date: Jan. 12, 2017

(54) LOST ANIMAL SAFETY DEVICE

(71) Applicant: DAVID BOYKIN WATERS, SIMPSONVILLE, SC (US)

(72) Inventor: DAVID BOYKIN WATERS, SIMPSONVILLE, SC (US)

(21) Appl. No.: 14/797,073

(22) Filed: Jul. 11, 2015

(51) Int. Cl. A01K 27/00

(52) U.S. Cl. CPC A01K 27/002; A01K 27/00; A01K 27/006; A01K 27/009

(57) ABSTRACT

A lost animal safety device is disclosed, comprising a harness having embedded features that reduce injury to, and enable fast recovery of, lost animals. The inventive device comprises a singular or plurality of fixed, portable or mobile wireless electronic leashes to transmit and receive wireless signals linked, paired or other wised matched by frequency, phase, algorithm, code or combination thereof to a singular or a plurality of corresponding animal harness-mounted transceiver units wherein detection of proximity is accomplished and logic determines sequence of events such as sounding an alarm, delivering a warning alert, deploying an instantly human recognizable safety marker and/or deploying a run inhibiting inflatable bladder to alert the owner, motorists, Samaritans and rescuers to the instant location and plight of the animal as well as slowing the animal to aid in recovery.

### CROSS REFERENCE TO RELATED APPLICATION

This application claims the benefit of U.S. Provisional Application No. 62/024,625 filed on Jul. 15, 2014, entitled “A Lost Animal Safety Device.”

### BACKGROUND OF THE INVENTION

Field of the Invention

The present invention relates to pet harnesses and leashes. More specifically, the present invention pertains to an animal harness having wireless connectivity to fixed and mobile devices in a manner that allows proximity to be determined and actions to be initiated to facilitate the rapid recovery of a pet that has strayed away from the desired location. The device provides for the deployment of a highly visible safety marker, audible alarm, flashing lights and an inflatable bladder to slow the movement of the pet. The device provides for convenience to the owner during normal daily activities like going for a walk, taking the pet to a park, beach or other location by multiple simultaneous mobile electronic leash connectivity. Applications of the present invention include the rapid location and safe recovery of a lost pet.

Statistically, one in three animals is lost at least once in their lifetime. Millions of pets are lost or stray outside of a safe zone (home or fenced area) annually. These animals are at severe risk of injury or death, many are hit by motor vehicles, and others are injured or perish from exposure, dehydration, starvation or by encounters with other animals.

Traditional methods of pet containment like fences, invisible fences, outdoor cables runs or relying on the pet to remain indoors are not adequate and do not allow the owner and pet to move about easily.

Pet location by geo-location devices like GPS, cellular and combinations thereof alert the owner to a pet's location, but may falsely report a pet lost when the owner is simply walking the pet. These devices may only provide the location of the pet every few minutes, allowing the animal to move far away from the reported location thus slowing recovery. These devices do not slow the animal nor alert the owner, motorists, Samaritans and rescuers to the location of the lost pet.

Subcutaneous embedded micro-chip identification and pet collar tag identification only helps identify a pet after it is recovered. The animal may be injured or killed before being recovered, therefore these devices are inferior for protecting a pet.

It is extremely difficult to identify an animal as a lost animal until it has been captured. Lost animal recovery is highly dependent on aid rendered by persons other than the owner. Most people will render assistance once alerted to the fact that an animal is lost and in need of assistance. The inability of others to instantly identify an animal as lost prevents rapid recovery assistance and increases the probability of loss, injury or death of a pet.

It is often difficult to locate a lost animal because they are colored in a manner that makes them difficult to see, they are small, quiet and fast. In darkness, they are nearly invisible. The inability to instantly detect the presence of a lost animal in all lighting conditions prevents rapid recovery and increases the probability of loss, injury or death.

If a lost animal is seen by others, it often appears as a stray, not as a lost pet, therefore an instant human detectable device that identifies an animal as lost, and such to elicit assistance from others is desired.

The use of electronic aids is valuable in animal location and recovery but does not add instant identification and location, therefore a device that may be supplemented by, but does not require the use of electronic aids by the rescuer is desired.

Presently, there are no available systems to simultaneously reduce injury, instantly identify as lost, assist location, reduce recovery time and also allow movement outside a predefined fixed location. To reduce loss, injury or death, a mobile device to make the animal instantly detectable to the owner, motorists, Samaritans and rescuers is desired.

The present invention solves the problems of animal loss, injury or death from motor vehicles by providing instant pre-recovery visual and audible identification, instant physical location, slowing of the animal to aid in recovery and allowing the owner the flexibility to move about freely without false alarm by detecting the animal's departure from mobile boundaries, automatically deploying a highly visual day/night safety marker, audibly alerting humans and slowing the animal's movement to aid in rapid recovery and reduce the chance of injury.

Description of Prior Art

Within the prior art there exists animal harnesses and collars having related identification and proximity features of varying design and function. These devices employ familiar design elements of harness, GPS transponders, and proximity sensors that communicate the position of the animal, allow communication to the animal and flash lights. Patents have been issued and patent applications published in the prior art for devices of these type, wherein the disclosures most relevant to the present invention are described below. These devices fail to disclose the novel aspects of the present invention, namely its safety marker, its feature to slow an animal, its ability to move about with the owner or any authorized person without falsely alarming.

Specifically, U.S. Pat. No. 8,543,134 to Lopez/Van Cheri describes a wireless two way voice communications device with lights and audible alarm to add visibility to the animal and aid in retrieving a lost animal. The Lopez/Van Cheri device relies on cellular communications which requires a service contract with a cellular carrier, increasing the cost of use whereas the present invention uses Bluetooth® and WI-FI as free services and has the added benefit of being embedded in most modern mobile phones, computers, tablets, wireless speakers, cars, stereos as well as other household and mobile devices. Lopez/Van Cheri device does not contemplate a safety marker to instantly alert the owner, motorists, Samaritans and rescuers of the lost animal and relies on LED lights that are low to the ground compared to that of the present invention.

The present invention is superior in design in providing a tall brightly colored safety marker which instantly alerts others visually and locates the LEDs and alarm high off the ground for increased visibility and audibility at distance as well as when in tall grass or brush. The present invention further provides for at distance human readable markings such as “LOST PET” to alert the owner, motorists, Samaritans and rescuers which is not contemplated by Lopez/Van Cheri. The present invention further provides for a method to slow the animal's movements, aiding in the rescue. The Lopex/Van Cheri device requires the use of a dedicated hand held unit whereas the present invention is compatible with any device with Bluetooth® or Wi-Fi built-in as well as dedicated devices specifically made for the present invention.

U.S. Pat. No. 6,067,018 to Skelton is another device that discloses a pet remote monitoring system that activates an alarm when a pet has left a certain area via wireless signal that relays to a base station. A portable unit is provided that allows tracking of the pet by GPS over cellular network. The base station then calls the owner. While providing a means to triangulate and locate a lost pet, the Skelton device does not contemplate adding visual safety markers, lights, alarm and a method to slow the pet. The Skelton device also relies on a cellular network, requiring a subscription with a cellular carrier which adds to the operating cost to the owner. The present invention is compatible with any device with Bluetooth® or Wi-Fi built-in as well as dedicated devices specifically made for the present invention.

Further, U.S. Pat. No. 7,411,492 to Greenburg describes a tracking system that uses GPS and modem for tracking a pet once it leaves a geo-fence. The Greenburg device is primarily a tracking device and relies on a base station and contemplates a shock warning to help prevent the escape from the geo-fenced area. The present invention is novel in the primary method of location is non-electronic. The present invention is superior as it enables rescue without the use of any electronic aid. The present invention further allows flexible, mobile area of containment based on the location of any one of a plurality of wireless leashes which the owner may employ. The present invention is capable of being electronically leashed to the owners' phone, key fob, computer, tablet, car, or other devices with a compatible wireless transmitter. The present invention allows the owner to leash the pet unit to a friend or pet sitter without purchase of additional devices because it is capable of linking to any Bluetooth® or Wi-Fi signal.

### SUMMARY OF THE INVENTION

In view of the forgoing shortcomings and disadvantages of know types of animal location and non-existence of effective lost pet safety systems in the prior art, the present invention provides a new animal harness safety system wherein the device launches a plurality of safety features to instantly alert the owner, motorists, Samaritans and rescuers to the plight of the lost animal while simultaneously slowing the animal's movement to aid in rescue and reduce the distance the pet can travel away from the desired area.

It is therefore an object of the present invention to provide a new and improved animal safety device that has the advantages with none of the disadvantages of the prior art and provides new and improved devices to visually and audibly alert the owner, motorists, Samaritans and rescuers of the instant location of the lost pet.

Another object of this invention to provide a new and improved method to slow a lost pet to aid in rescue and reduce the search area.

Another object of this invention to provide a new and improved method to allow a plurality of non-dedicated mobile devices to act as electronic leashes.

Another object of this invention to provide a new and improved method to deploy inflatable components by use of an electrically controlled, compressed gas release valve capable of being powered by lightweight portable battery.

### BRIEF DESCRIPTION OF THE DRAWINGS

Although the novel features of this invention will be pointed out in the claims, the invention itself and manner in which it may be made and used may be better understood after a review of the following description and drawings wherein numeral annotations are provided throughout.

FIG. 1 shows a flow diagram of the functionality of the present device.

FIG. 2 shows a block diagram of the slave unit(s).

FIG. 3 shows a block diagram of the master unit(s).

FIG. 4 shows a perspective view of the present invention safety marker.

FIG. 5 shows a top view of the present invention container components.

FIG. 6 shows a front view of the present invention container components.

FIG. 7 shows side view of the present invention container components.

FIG. 8 shows a perspective view of the present inventions harness and deployed safety marker.

FIG. 9 shows a perspective view of the present inventions harness, safety marker and anti-run device as worn on an animal in a deployed state.

FIG. 10 shows a perspective view of the present inventions harness, safety marker and anti-run device as worn on an animal in a non-deployed state.

FIG. 11 shows a cross section view of the present invention electrically controlled compressed gas release valve.

FIG. 12 shows a cross section view of the present invention electrically controlled compressed gas release valve, housing and compressed gas cylinder.

FIG. 13 shows the multiple master devices simultaneous connection to one or more slave units.

### DETAILED DESCRIPTION OF THE INVENTION

Reference herein is made to the attached drawings. Like reference numerals are used throughout to depict like or similar elements of the present invention. For the purposes of presenting a brief and clear description of the present invention, the preferred embodiment will be discussed. The figures are intended for representative purposes only and should not be considered to be limiting in any respect.

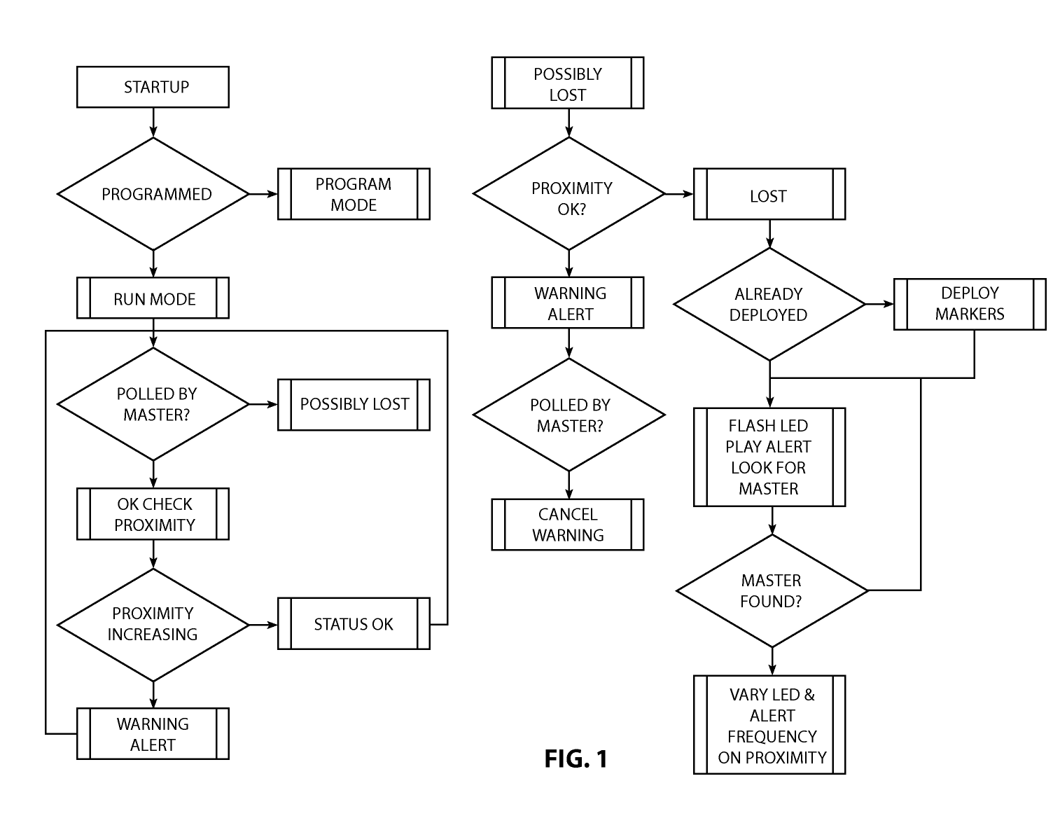

Referring now to FIG. 1, there is shown a flow diagram outlining example operational usage of the present invention, herein several scenarios and operational choices are displayed. The goal of this flow diagram is to outline an operational outline for the device, wherein its internal programming is set to operate specific logic and take specific action based on specific conditions.

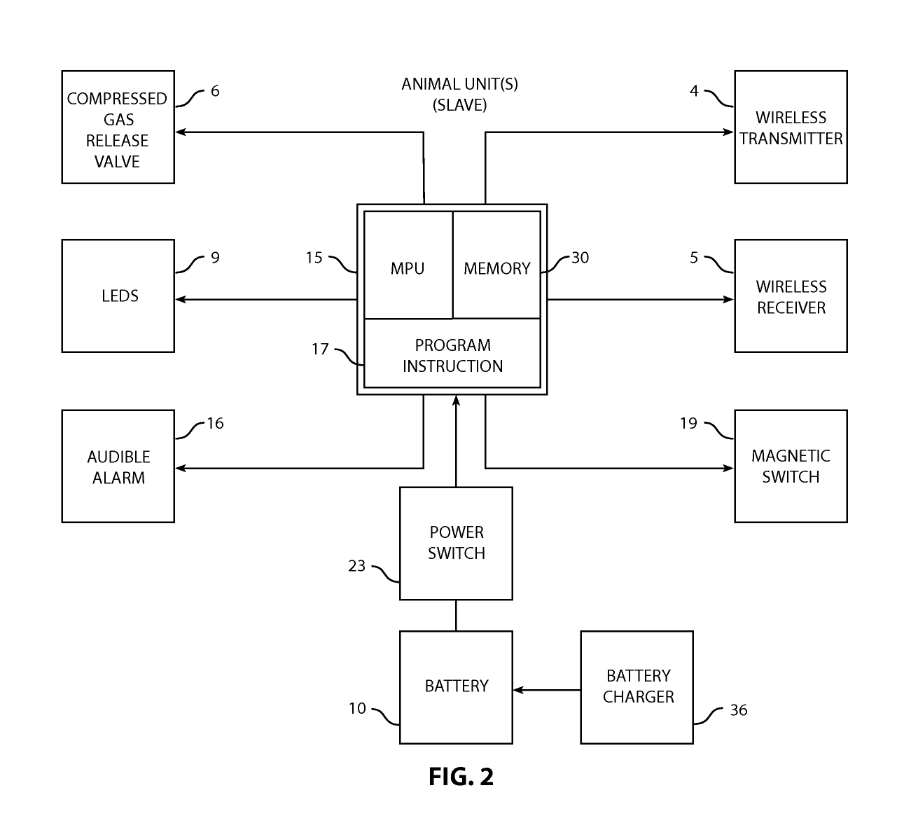

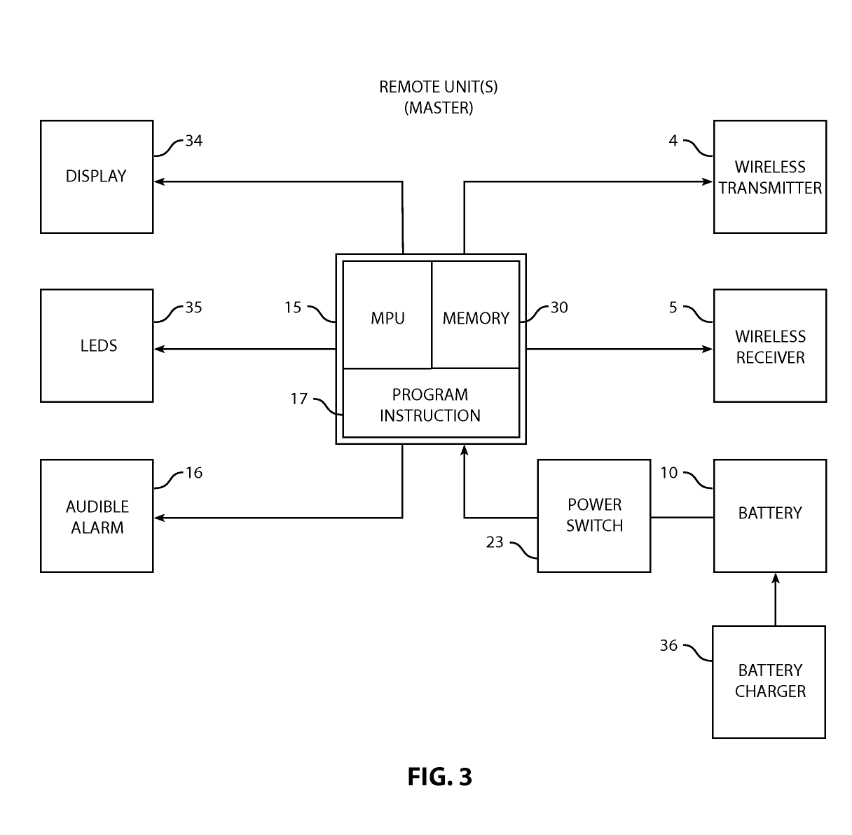

The device will be programmed to bind one or more slave units FIG. 2 with one or more master units FIG. 3 wherein the slave and master can be distinguished from another instance of the present invention that may be in operation in proximity to each other. An example of such a case is where neighbors are both using the present invention. Programming is performed and then stored in memory for convenience of the user. The master unit is similarly programmed wherein masters and slaves logically combine to operate as a system. Master units search for slave units and connect to slave units.

This connection is analyzed programmatically by both the master and the slave units to determine proximity. The connection is released and the master and slave units enter a power saver mode wherein overall power consumption is reduced and battery life optimized.

Programmatic logic will analyze the number of connections and proximity over time and take actions based on the outcome of the analysis. Power saving mode is dynamically adjusted based on the outcome of the analysis to minimize deployment time while simultaneously maximizing battery life.

In the example of FIG. 1, a warning alert may be issued if the distance between the units is increasing thereby alerting the owner, animal or both. If connection is lost or proximity exceeds a predetermined or dynamically determined threshold, the unit will enter lost mode wherein it will deploy the safety device(s) and flash lights and play sounds to alert the owner, motorists, Samaritans and rescuers. Proximity is used to vary the alerting lights and sounds proportionally to proximity as an additional aid to animal location.

Referring now to FIG. 2, there is shown a functional block diagram of a slave unit. The slave unit is attached to the animal harness 25 wherein a Micro Processor Unit (MPU) 15 interconnects with compressed gas release valve 6, LEDs 9, audible alarm 16, wireless transmitter 4, wireless receiver 5, magnetic switch 19, power switch 23, battery 10 and battery charger 36. The devices work together to enable the features of the present invention. MPU 15 comprises a microprocessor, program instructions 17, volatile and non-volatile memory 30 wherein parameters and variables may be stored temporarily or permanently. MPU 15, wireless transmitter 4 and wireless receiver 5 are depicted as separate logical functions but are contained within a single device in the preferred embodiment, although discrete components may also be used.

In the preferred embodiment of the present invention, the wireless transmitter 4 and wireless receiver 5 are Bluetooth® compatible. The preferred embodiment contemplates use of both a wireless transmitter 4 and wireless receiver 5, however the present invention may be used with only a wireless receiver 5 alone wherein programmatic logic is altered to accomplish proximity utilizing only a wireless receiver 5 wherein any Bluetooth® device with transmitter may act as a master.

In the preferred embodiment of the present invention, the optional magnetic switch 19 utilizes a Hall Effect sensor which may be substituted with devices like magnetic reed switch, contact switch, air pressure switch or other device to determine the deployed condition of the present invention. In the preferred embodiment of the present invention, the optional LED 9, audible alarm 16 and battery charger 36 are included to enhance the safety features of the present invention, but may be substituted or eliminated in other embodiments.

Referring now to FIG. 3, there is shown a functional block diagram of the preferred embodiment of a master unit 26. The master unit 26 may be a portable or fixed location or its functions provided by smartphone or any other device with at least a wireless transmitter 4. Optional Micro Processor Unit (MPU) 15 interconnects with display 34, LEDs 35, audible alarm 16, wireless transmitter 4, wireless receiver 5, power switch 23, battery 10 and battery charger 36. The devices work together to enable the features of the present invention. MPU 15 comprises a microprocessor, program instructions 17, volatile and non-volatile memory 30 wherein parameters and variables may be stored temporarily or permanently. MPU 15, wireless transmitter 4 and wireless receiver 5 are depicted as separate logical functions but are contained within a single device in the preferred embodiment, although discrete components may also be used. In the preferred embodiment of the present invention, the wireless transmitter 4 and wireless receiver 5 are Bluetooth® compatible.

The preferred embodiment contemplates use of both a wireless transmitter 4 and wireless receiver 5; however the present invention master unit 26 may be comprised of only a wireless transmitter 4 alone wherein programmatic logic of the slave device is altered to accomplish proximity utilizing only a wireless receiver 5.

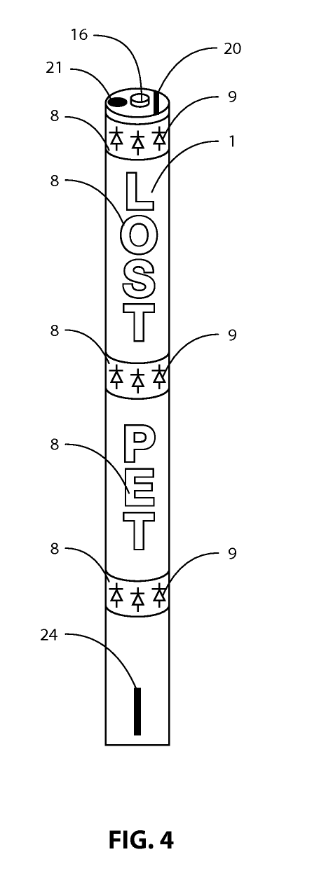

Referring now to FIG. 4, there is shown a perspective view of the present invention safety marker 1. In the preferred embodiment, the safety marker 1 is an inflatable tube constructed of lightweight, abrasion resistant, flexible material of a singular or a plurality of highly human visible colors including but not limited to orange, yellow, red and green, compressed gas inlet tube 24, reflective material in various shapes, sizes and colors 8, a plurality of Light Emitting Diodes (LED) 9, audible alarm 16, permanent magnet 20, and pressure relief mechanism 21.

Conductive wiring of sufficient diameter and length to connect components 12, fabric stitching of sufficient length and strength to connect fabric components together 13, adhesive of sufficient type, strength and quantity to secure components 14, conductive thread of sufficient diameter, conductance and length to connect components 18 are not specifically called out in the drawing but are used to make and connect components of the present invention.

The safety marker 1 is deployed to alert the owner, motorists, Samaritans and rescuers to the instant location and plight of the animal. The safety marker 1 is deployed vertically over the animal when the electrically released compressed gas passes through the compressed gas inlet tube(s) 24. The permanent magnet 20 moves away from magnetic switch 19, to indicate to the MPU 15 that the safety marker is deployed.

The bright colors of the safety marker 1 combine with the reflective material 8 and LED 9 to create a highly visible safety marker to alert the owner, motorists, Samaritans and rescuers of the instant location of the lost pet in daylight, fog and in low light conditions. The audible alarm 16 alerts the owner, motorists, Samaritans and rescuers of the instant location of the lost pet by sound wave. The preferred embodiment of the present invention also includes words like ‘LOST PET’ to aid in instantly identifying the animal as a lost pet. Variations of shape, size, number of components, and location of components are contemplated to provide for various options like size and shape of animals, mounting options and to increase the effectiveness of the device.

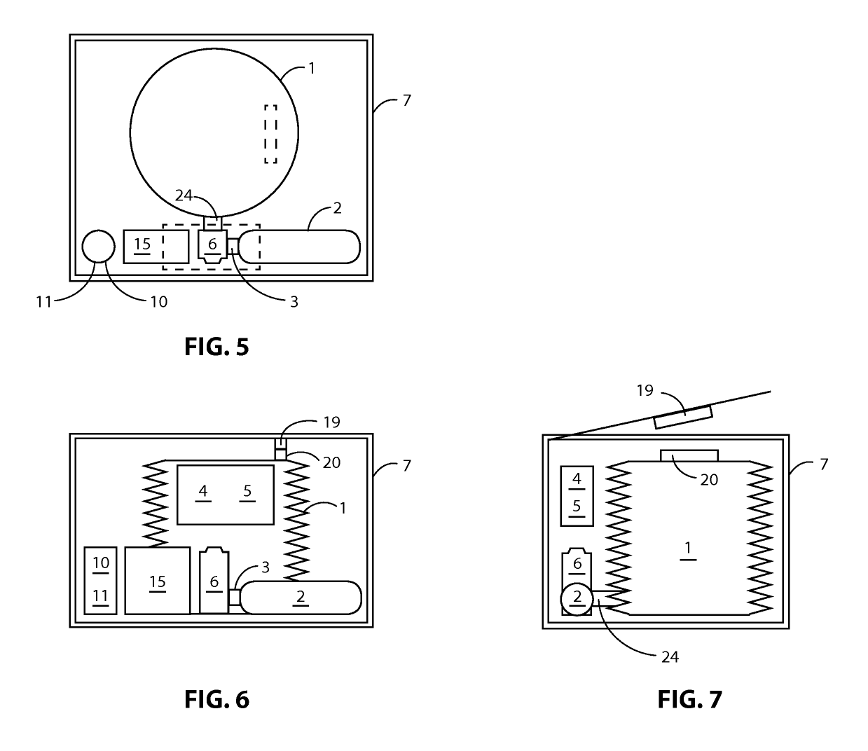

Referring now to FIG. 5, FIG. 6, FIG. 7 there is shown a top (FIG. 5), front (FIG. 6) and side (FIG. 7) perspective views of the present invention harness mounted components comprised of container 7, safety marker 1, magnetic switch 19, MPU 15, wireless transmitter 4, wireless receiver 5, compressed gas cylinder 2, compressed gas pressure reducer/regulator 3, compressed gas release valve 6, compressed gas inlet tube 24, battery 10, battery holder 11, and permanent magnet 20.

Conductive wiring of sufficient diameter and length to connect components 12, fabric stitching of sufficient length and strength to connect fabric components together 13, adhesive of sufficient type, strength and quantity to secure components 14, conductive thread of sufficient diameter, conductance and length to connect components 18 may not be specifically called out in a drawing but are used to make and connect components of the present invention.

The preferred embodiment contains these components within container 7 which is comprised of a flexible, water resistant material of sufficient in size and volume as to contain all required or optional components with integral fasteners, integral animal harness mounting and plurality component pockets.

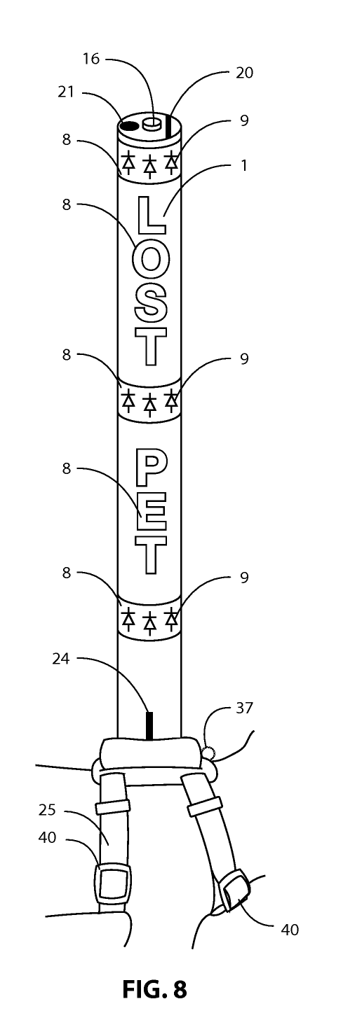

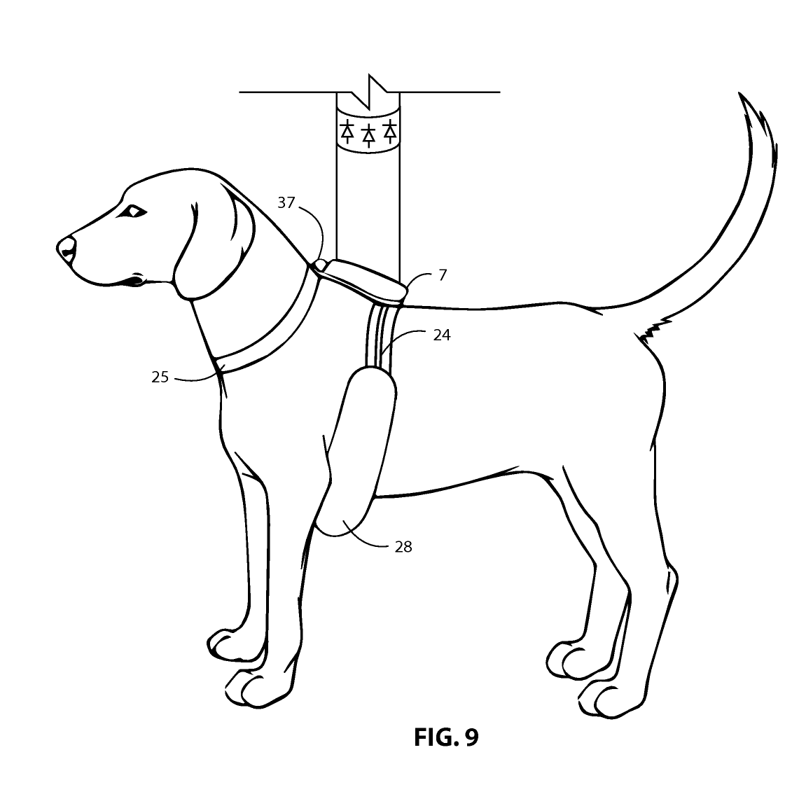

Referring now to FIG. 8, there is shown a perspective view of the present invention container 7, deployed safety marker 1, mounted on animal harness 25 comprised of sturdy flexible material and plurality of connective buckles 40 and hand held flexible leash connection D ring 37. The hand held flexible leash connection D ring 37 is used to connect a leash to be held by the owner for walking the animal, or may be used to connect the harness to a tie out, dog run, vehicle restraint system or any other object such to secure the animal's relative position to the object. Compressed gas inlet tube 24 is shown for illustrative purposes, but is internally connected to the compressed gas system contained within the container 7. Connective buckles 40, are used to facilitate attaching the harness to and removing it from the animal.

Referring now to FIG. 9, there is shown a perspective view of the present invention container 7, deployed safety marker 1, deployed anti-run inflatable bladder 28, compressed gas inlet tube 24, mounted on animal harness 25 comprised of sturdy flexible material and plurality of connective buckles 40 and hand held flexible leash connection D ring 37.

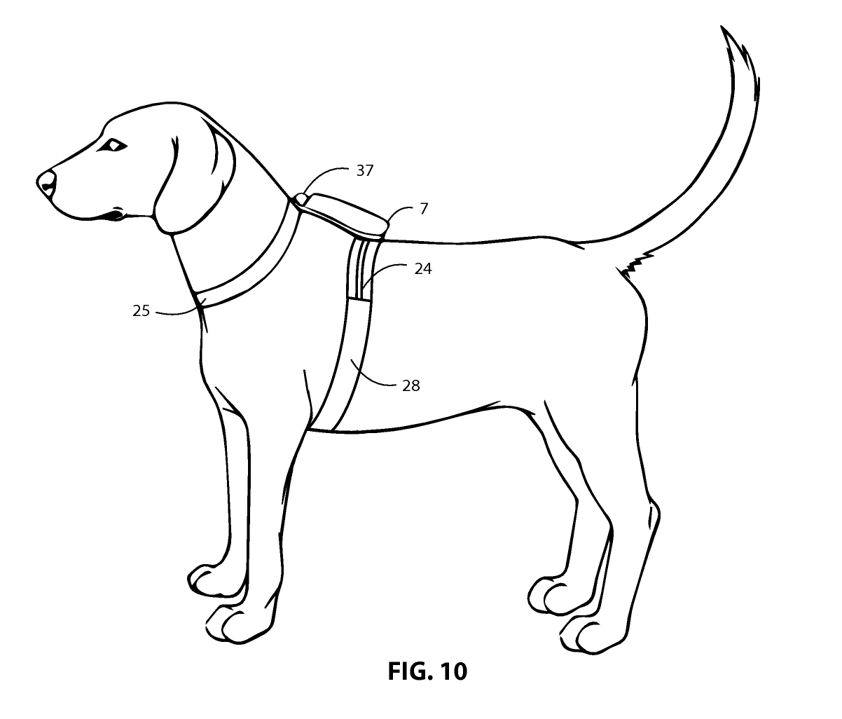

Referring now to FIG. 10, there is shown a perspective view of the present invention container 7, non-deployed safety marker 1, non-deployed anti-run inflatable bladder 28, compressed gas inlet tube 24, mounted on animal harness 25 comprised of sturdy flexible material and plurality of connective buckles 40 and hand held flexible leash connection D ring 37. Compressed gas inlet tube 24 is shown for illustrative purposes, but is contained within the internal cavities of the animal harness 25 and connected to the compressed gas system contained within the container 7.

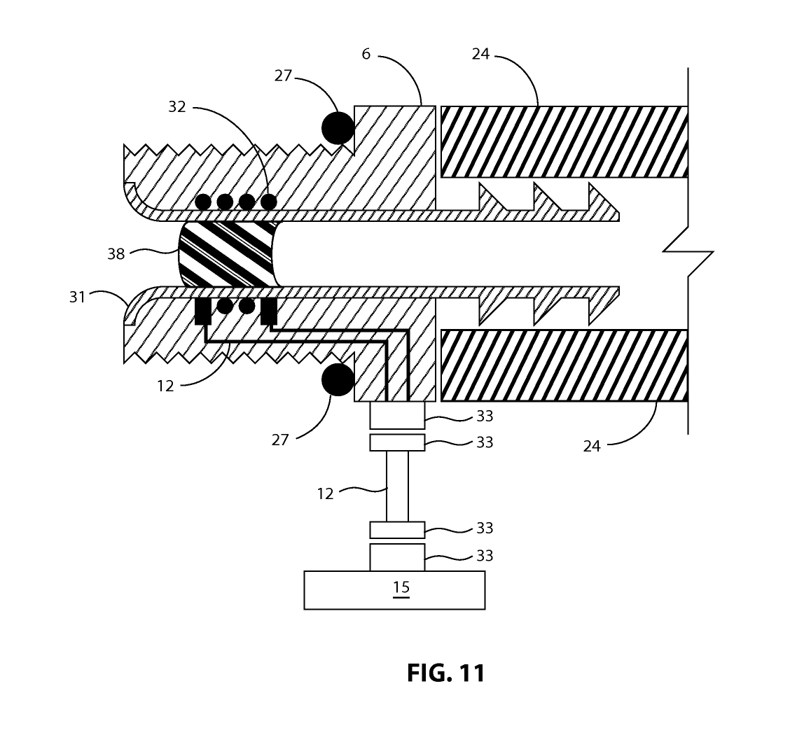

Referring now to FIG. 11, shows a cross section view of the present invention electrically controlled compressed gas release valve 6 comprised of electrically non-conductive heat resistant material 6, compressed gas outlet tube 31, heat resistance wire 32, electrical connectors of sufficient size and quantity to connect electrical components 33, heat liquefiable substance 38, O ring 27 and conductive wire 12. The compressed gas outlet tube 31 is connected to the compressed gas inlet tube 24 of safety marker 1 and/or anti-run inflatable bladder 28. Electrically controlled compressed gas release valve 6 is connected to MPU 15 by conductive wire 12 and electrical connectors 33.

The electrically controlled compressed gas release valve 6 prevents the flow of compressed gas outside the device by O ring seals 27 and inside the device through the compressed gas outlet tube 31 by heat liquefiable substance 38 located inside the compressed gas outlet tube 31. The heat liquefiable substance 38 has physical properties such that it is a gas impenetrable solid at ambient temperatures and is a liquid at higher temperatures. Examples include solder (tin/lead, silver or other), epoxies, glues, plastics, nylons, synthetics, hybrids or any other suitable material where the solid states remains throughout a range of animal survivable temperatures, and where the liquid state is achieved at a temperature lower than the melting point of the housing. This substance and process may be replaced with a Peltier device where the temperature may be both raised and lowered to change the physical state of the substance.

Electrical current controlled and commanded by the MPU 15 passes through heat resistance wire 32, generating temperatures sufficient to reduce the viscosity of heat liquefiable substance 38 to the point its physical state becomes plastic or liquid and allows compressed gas to flow through the compressed gas outlet tube 31 into the compressed gas inlet tube 24 thereby inflating the safety marker 1 and/or the anti-run inflatable bladder 28.

The electrically controlled compressed gas release valve 6 is contemplated to be inexpensive and disposable in the preferred embodiment, but it is also contemplated to be reusable by containing heat liquefiable substance 38 within a confined area within compressed gas outlet tube 31 wherein the heat liquefiable substance 38 will allow the flow of compressed gas while heated and not allow the flow of compressed gas when cooled, remaining within the compressed gas outlet tube confined area. This allows the heat liquefiable substance 38 to act as a reusable compressed gas control valve controlled by the MPU 15.

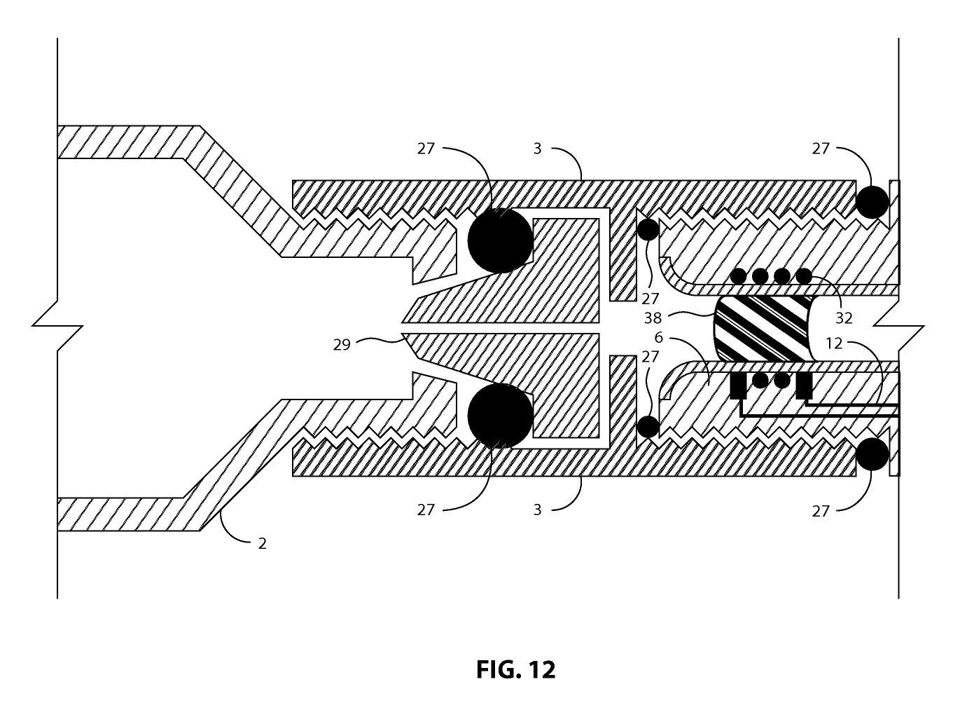

Referring now to FIG. 12, shows a cross section view of the present invention compressed gas pressure reducer/regulator 3 comprised of housing 3, internal chambers, passages and threading, compressed gas cylinder puncture pin 29, O rings 27, compressed gas cylinder 2, and electrically controlled compressed gas release valve 6. Compressed gas cylinder 2 is threaded into housing 3 with sufficient force to cause the compressed gas cylinder puncture pin 29 to puncture the compressed gas cylinder 2 and allow the compressed gas to flow through the internal passages and into the exhaust chamber area. The electrically controlled compressed gas release valve 6 is threaded into the exhaust chamber area and seals compressed gases by use of O rings 27 and heat liquefiable substance 38.

This system contains the compressed gas until ready for deployment and creates an electrically controllable compressed gas system.

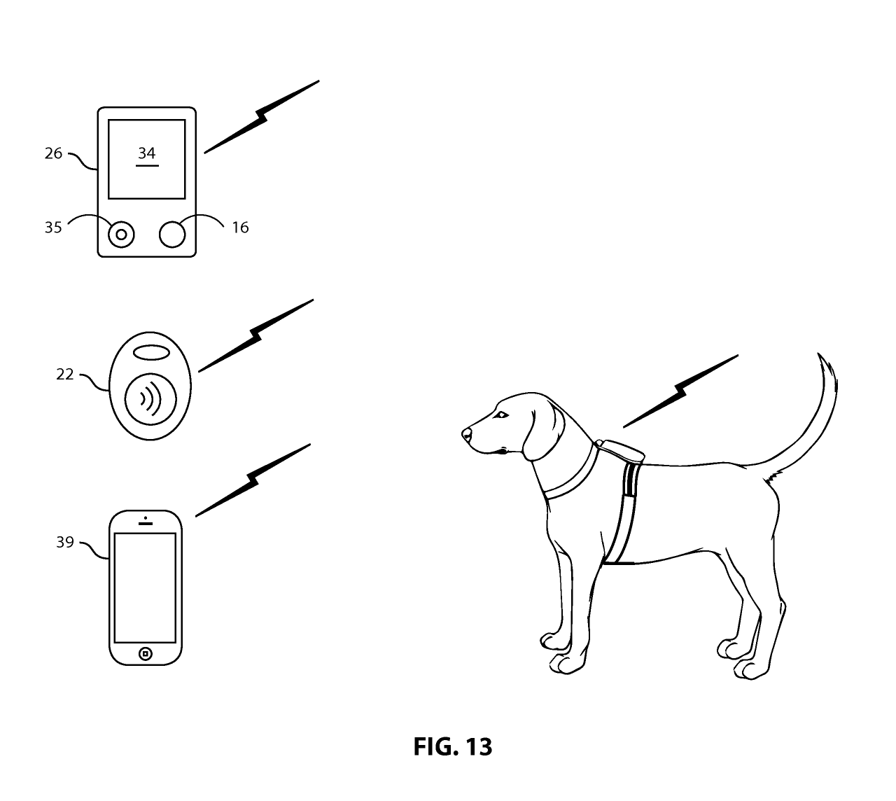

Referring now to FIG. 13, shows the multiple master devices simultaneous connection to one or more slave units. Master unit 26, electronic key fob 22 and mobile smartphone 39 are used to wirelessly transmit a signal to the animal mounted slave device. In the preferred embodiment, the master unit 26 comprises Micro Processor Unit (MPU) 15, display 34, LEDs 35, audible alarm 16, wireless transmitter 4, wireless receiver 5, power switch 23, battery 10 and battery charger 36.

The preferred embodiment of the electronic key fob 22 comprises Micro Processor Unit (MPU) 15, wireless transmitter 4, wireless receiver 5, and battery 10. In other embodiments it is contemplated to include display 34, LEDs 35, audible alarm 16, power switch 23 and battery charger 36.

Smartphone 39 comprises Micro Processor Unit (MPU) 15, display 34, LEDs 35, audible alarm 16, wireless transmitter 4, wireless receiver 5, power switch 23, battery 10 and battery charger 36 although these components are built-in by the manufacturer and are designed as multipurpose devices. These smartphones are used with the present invention by utilization of program instruction 17, which is loaded on said smartphone thus enabling the multipurpose and ubiquitous smartphone 29 to act as a master unit 26 by use of program instruction 17.

One or more of these devices (master device 26, electronic key fob 22, smartphone 39) as well as any Wi-Fi or Bluetooth® enabled device may be used to wirelessly communicate with a plurality of slave devices such that multiple devices act as electronic leashes to multiple animals within the present inventions preferred embodiment.

When proximity between any master device and any slave device exceeds a predetermined or dynamically determined radius, the slave device deploys the present invention safety device(s).

Overall, the present invention provides a new safety system for lost pets wherein proximity is determined using wireless transmitters and receivers between a plurality of masters and a plurality of slaves to deploy highly humanly detectable safety devices by controlled release of compressed gases, to alert the owner, motorists, Samaritans and rescuers to the plight of the lost animal while simultaneously slowing the animal's movement to aid in rescue and reduce the distance a pet can travel away from the desired area.

Lost or injured animals can be an emotional and financial tragedy for owners as well as for motorists that may accidentally injure or kill someone's pet. Damages to the vehicle, emotional stress, litigation and other issues complicate and increase the magnitude of the problem.

In light of the present disclosure and the related prior art, it is submitted that the instant invention has been shown and described to be the most practical and preferred embodiments. It is recognized, however, that departures may be made within the scope of the invention and that are obvious modifications will occur to those skilled in the art. With respect to the above description then, it is to be realized that the optimum dimensional relationships for the parts of the invention, to include variations in size, materials, color, shape, form, function and manner of operation, assembly and use, are deemed readily apparent and obvious to one skilled in the art, and all equivalent relationships to those illustrated in the drawings and described in the specification are intended to be encompassed by the present invention.

Therefore the forgoing is considered as illustrative only of the principles of the present invention and further since numerous modifications and changes will readily occur to those skilled in the art, it is not desired to limit the invention to the exact construction and operation shown and described, and accordingly, all suitable modifications and equivalents may be resorted to, falling within the scope of the present invention.

What is claimed is:

1. A lost animal safety device, comprising:
an animal harness having a plurality of internal and external cavities, housing area, at least a first and at least a second ends having removable attachment means;
said harness adapted to encircle the neck and body of an animal and provide a means to support a plurality of internal and external components;
said components comprising at least one battery, at least one wireless receiver, at least one compressed gas release valve, at least one compressed gas vessel and at least one inflatable safety marker;
wherein said components are configured to determine proximity to one or more fixed or portable wireless transmitters and determine if the device has moved outside of one or more desired fixed or portable radius areas and to deploy said inflatable safety marker to visually alert others.

2. The device of claim 1, further comprising at least one inflatable bladder that impedes the movement of at least one or more of the animal's legs;

3. The device of claim 1, further comprising a plurality of light sources.

4. The device of claim 1, further comprising at least one audible alarm.

5. The device of claim 1, further comprising at least one pressure release valve.

6. The device of claim 1, further comprising at least one magnetically activated switch and at least one permanent magnet.

7. The device of claim 1, further comprising at least one wireless transmitter.

8. The device of claim 1, further comprising at least one Microprocessor Unit, at least one programmatic logic and at least one memory storage.

9. The device of claim 1, further comprising one or more mobile wireless transmitters not attached to said harness.

10. A lost animal safety device, comprising:
an animal harness having a plurality of internal and external cavities, housing area, first and second ends having removable attachment means;
said harness adapted to encircle the neck and body of an animal and provide a means to support a plurality of internal and external components;
said components comprising at least one battery, at least one wireless receiver, at least one compressed gas release valve, at least one compressed gas vessel and at least one inflatable bladder that impedes the movement of at least one or more of the animal's legs;
wherein said components are configured to determine proximity to one or more fixed or portable wireless transmitters and determine if the device has moved outside of one or more desired fixed or portable radius areas and deploy said inflatable bladder to physically impede rapid movement of the animal.

11. The device of claim 10, further comprising at least one inflatable safety marker;

12. The device of claim 10, further comprising a plurality of light sources.

13. The device of claim 10, further comprising at least one audible alarm.

14. The device of claim 10, further comprising at least one pressure release valve.

15. The device of claim 10, further comprising at least one magnetically activated switch and at least one permanent magnet.

16. The device of claim 10, further comprising at least one wireless transmitter.

17. The device of claim 10, further comprising at least one Microprocessor Unit, at least one programmatic logic and at least one memory storage.

18. The device of claim 10, further comprising one or more mobile wireless transmitters not attached to said harness.

19. An electrically controlled compressed gas release valve comprising a compressed gas tube, heat resistance wire and heat liquefiable solid substance;
wherein said components are configured to impede the flow of a compressed gas by said heat liquefiable solid substance at ambient temperatures and allow the flow of said compressed gas by application of an electrical current to said heat resistant wire thus heating the said heat liquefiable solid substance to sufficient temperatures as to change the physical properties from solid to plastic, liquid or gas state.
